(19) United States
(12) Patent Application Publication
(10) Pub. No.: US 2016/0018234 A1
(43) Pub. Date: Jan. 21, 2016

(54) LOCAL DESTINATION ENTRY

(71) Applicant: NAVIGATION SOLUTIONS, LLC, Plano, TX (US)

(72) Inventors: Michael Mouser, Parker, TX (US); Donald Finney, West Bloomfield, MI (US); Philip A. Weaver, Plano, TX (US)

(21) Appl. No.: 14/739,429

(22) Filed: Jun. 15, 2015

Related U.S. Application Data
(60) Provisional application No. 62/012,156, filed on Jun. 13, 2014.

(51) Int. Cl. G01C 21/36; G01S 19/42; H04W 4/02

(52) U.S. Cl. CPC G01C 21/3623; H04W 4/027; G01S 19/42

(57) ABSTRACT

A navigation system includes a media reader that can be used to select a destination very quickly. The user presents a code or media to the media reader. A processor in the navigation system receives the code or information on the media from the media reader. The processor obtains a destination based upon the code and provides a route from the current position to the destination.

### BACKGROUND

The present invention provides a navigation system with improved ways of entering a destination or other information. At times, selecting a destination on a navigation system can be time-consuming. In the case of a navigation system installed in a rental vehicle, the user is by definition in an unfamiliar geographic area using a navigation system with which he may be unfamiliar. Even in the best of circumstances, entering a street address takes some time.

### SUMMARY

A navigation system includes a media reader that can be used to select a destination very quickly. The user presents a code or media to the media reader. A processor in the navigation system receives the code or information on the media from the media reader. The processor obtains a destination based upon the code and provides a route from the current position to the destination.

The media reader may be a camera in which case the user may present a QR code or bar code to the media reader. The code may be transmitted by the processor to a remote server which translates the code to an associated destination. The destination is returned to the processor for route calculation. Alternatively, the route can be calculated by the server and returned to the processor. Alternatively, the user can present a business card, flyer or brochure containing a printed address that the camera can recognize and convert to an address for the destination.

The media reader may also be a local wireless circuit, such as an NFC reader. The user can present an NFC chip to the NFC reader. The NFC chip may contain an address or a code that can be translated at the server.

### BRIEF DESCRIPTION OF THE DRAWINGS

FIG. 1 is a front view of a navigation system according to one embodiment of the present invention.

FIG. 2 is a schematic of the navigation system of FIG. 1.

### DESCRIPTION OF A PREFERRED EMBODIMENT

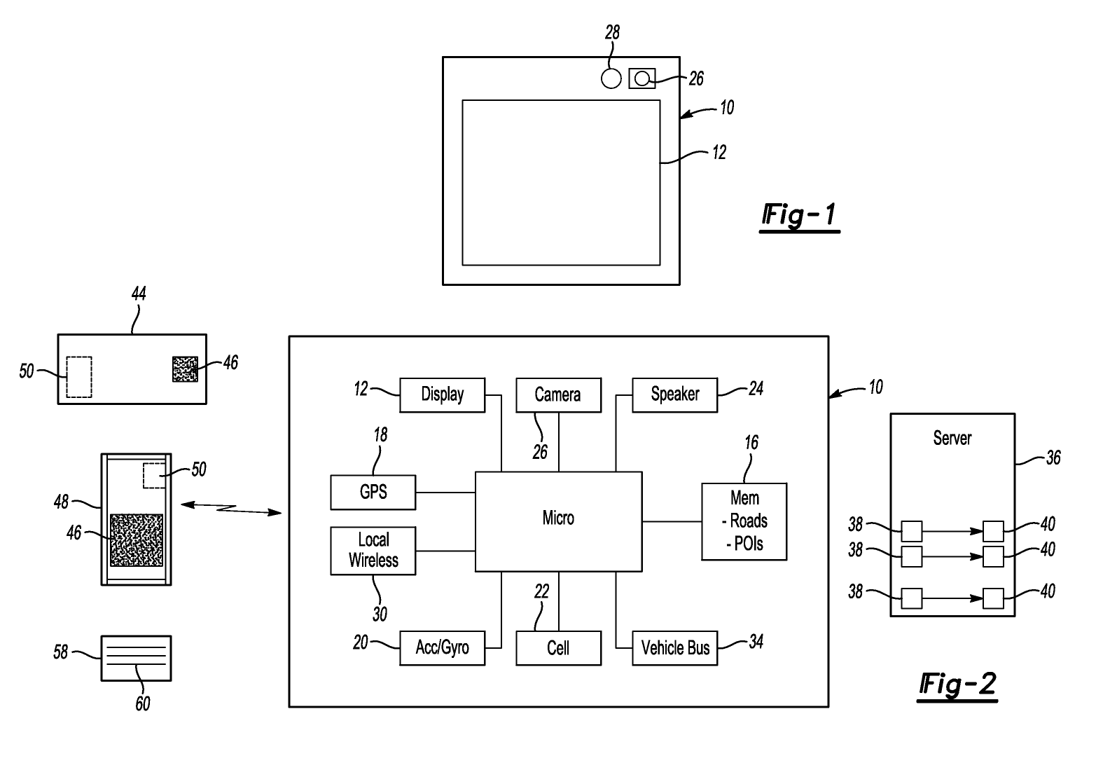

A navigation system 10 according to one example of the present invention is shown in FIG. 1. The navigation system 10 may include a display 12, which may be a touchscreen display. The navigation system may be installed or at least located in a vehicle (not shown). The navigation system 10 includes a camera 26 and a flash 28 (such as an LED flash) proximate the camera 26.

The example embodiment of the navigation system 10 is shown and described herein as installed into a vehicle; however, it should be noted that the navigation system 10 could be installed as part of the OEM vehicle equipment, as part of the vehicle interior, or as shown, as a separately installed appliance. The particular example described below is in the context of a navigation system in a rental vehicle. Again, this context is primarily for purposes of illustration, as the invention is not limited to rental vehicles or to vehicles.

FIG. 2 is a high-level schematic showing some components of the navigation system 10, again in the exemplary configuration as part of a navigation system. The navigation system 10 includes at least one microprocessor 14 having memory 16 (or other computer accessible storage). The memory 16 stores the programs executed by the microprocessor 14 for performing the functions described herein. The memory 16 also stores a database of roads and a database of points of interest to which the user can request a route via the roads. The databases of roads and points of interest may cover a plurality of states, provinces and/or countries. Of course, the microprocessor 14 could be multiple microprocessors or multiple cores or multiple virtual processors and the memory 16 could be any combination of electronic, magnetic, optical or even off-board storage.

The navigation system 10 may also contain one or more position-determining devices, such as GPS 18, accelerometer/gyro 20, etc. The navigation system 10 may be in communication with the vehicle bus 34 (e.g. OBD-II or variations thereof), which can provide speed and distance information. The navigation system 10 may include wireless communication, such as cell circuitry 22. The navigation system 10 may include a speaker 24 for communicating routing instructions to the driver. The navigation system 10 may include local wireless communication circuitry 30, such as NFC, Bluetooth, WiFi, WiFi Direct, Bluetooth or Bluetooth Low Energy (BLE), or the like, as newer communication protocols are developed.

The particular configuration of the hardware, route guidance and position-determining hardware and software is not critical to the present invention. Many configurations are known. As is also known, the navigation system 10 permits a user to select a destination from the databases of roads and points of interest. The navigation system 10 can then calculate a route via roads in the roads database to the selected destination from the current location of the navigation system 10. The navigation system 10 displays the route and/or communicates turn-by-turn instructions to the user as the navigation system 10 follows the recommended route.

Referring to FIG. 2, the present system provides several additional convenient ways to enter destinations on the navigation system 10.

First, QR codes or barcodes or other visible codes could be could be read by the camera 26 in the navigation system 10. The code 46 could be on a paper media 44, such as on printed material, brochure, advertising literature, card, etc. Alternatively, the code 46 could be displayed on an electronic display such as on a portable electronic device 48 such as a mobile phone, tablet, iPod, etc. The navigation system 10 may be in communication (e.g. via cell circuitry 22 to cell towers for connection to the internet, as is known) with one or more remote servers 36. The server 36 includes coded entries 38 that link a code 46 to the destination 40 (e.g. lat/long, street address, franchise name, etc) or set of destinations 40. The code 46 is read by the camera 26 and the navigation system 10 may transmit the code 46 to the server 36 to retrieve a destination which may specifically reference the database of roads (e.g. a lat/long, lat/long/altitude or street address) or a point of interest more generally (e.g. a particular brand of hotel or restaurant, the nearest one of which can be found by the navigation system). The destination is then used as the destination for calculation of a route by the navigation system.

As another alternative, the portable electronic device 48 or the media 44 may include an NFC chip 50 or other local wireless connectivity compatible with local wireless communication circuitry 30 on the navigation system 10. The media 44 may be a smart business card, smart advertising literature, etc, with a specific destination stored on (or accessible via) the NFC chip 50 (again it could be a lat/long, lat/long/altitude, street address, name) or the NFC chip 50 may be associated with a coded entry 38 on the server 36 where the destination is stored. In any event, the NFC chip 50 could also reference multiple locations (e.g. by reference a chain of restaurants or hotel by name).

If the portable electronic device 48 is used, in addition to the above options, the user can also choose a specific address from the user's address book, browsed website, an email, etc. and send it to the navigation system 10 via the local wireless communication circuitry 30. As another alternative, the NFC chip 50 on the portable electronic device 48 can be used to read NFC stored information on smart media, which is then transmitted to the navigation system via Bluetooth, WiFi, or some other local wireless communication protocol, via local wireless communication circuitry 30.

As yet another alternative, the camera 26 could be used to read an address 60 from a business card 58. The image from the camera 26 is converted to the letters and numbers of the address and may be used to access a destination in the database in memory 16.

The invention is not limited to choosing destinations for route calculation. A destination may also have other associated information that can be presented to the user. For example, a restaurant destination may also enable the user to obtain business hours of operation, contact information, coupons, advertising, home size, property tax information. Additionally, any of the above methods could be used to provide audible information related to the destination.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A navigation system comprising:
at least one position-determining device capable of providing a current position;
a media reader; and
a processor receiving a code from the media reader, the processor programmed to obtain a destination based upon the code and to provide a route from the current position to the destination.

2. The navigation system of claim 1 wherein the media reader is a camera.

3. The navigation system of claim 2 wherein the code is a QR code.

4. The navigation system of claim 3 wherein the code is a bar code.

5. The navigation system of claim 1 wherein the media reader is a local wireless device.

6. The navigation system of claim 5 wherein the local wireless device is an NFC device.

7. The navigation system of claim 1 wherein the at least one position-determining device is a global navigation satellite receiver.

8. The navigation system of claim 1 further including a remote server, the processor programmed to send the code to the remote server and receive a destination from the remote server in response to the code.

9. A method for selecting a destination including the steps of:
a) receiving a code at a processor;
b) transmitting the code with the processor to a remote server; and
c) receiving a destination at the processor from the remote server in response to said step b).

10. The method of claim 9 wherein said step a) further includes the step of taking an image with a camera.

11. The method of claim 10 wherein the image includes a QR code.

12. The method of claim 10 wherein the image includes a bar code.

13. The method of claim 9 wherein said step a) further includes the step of reading an NFC chip.

14. The method of claim 9 further including the step of determining a route from the current location to the destination.

15. The method of claim 9 further including the step of the server retrieving the destination based upon the code and transmitting the destination to the processor.

16. A method for selecting a destination in a navigation system including the steps of:
a) taking an image with a camera;
b) receiving the image at a processor; and
c) determining a destination at the processor based upon the image.

17. The method of claim 16 wherein the image includes an address.

18. The method of claim 16 wherein the image includes a QR code.

19. The method of claim 16 wherein the image includes a bar code.

20. The method of claim 16 further including the step of, after said step c), determining a route from a current location to the destination.
